(19) United States
(12) Patent Application Publication
(10) Pub. No.: US 2011/0307733 A1
(43) Pub. Date: Dec. 15, 2011

(54) ELECTRICAL CHARGE AND DISCHARGE CIRCUIT, AND AN EMBEDDED CONTROLLER

(75) Inventor: Motoyoshi TOKUNAGA, Hitachinaka (JP)

(73) Assignee: HITACHI, LTD.

(21) Appl. No.: 13/159,479

(22) Filed: Jun. 14, 2011

(30) Foreign Application Priority Data
Jun. 14, 2010 (JP) 2010-134811

(51) Int. Cl. G06F 1/28; H02J 7/04

(52) U.S. Cl. 713/340; 320/117

(57) ABSTRACT

This invention provides an electrical charge and discharge circuit suitable for supplying power for backup operation function to a system power source with use of a battery module for low voltage. The battery modules are connected in parallel, in case of charging to the battery modules, and the battery modules are serially connected, in case of discharging charged power and supplying power to the load. This invention also comprises a contact switch provided between a plus terminal and a minus terminal of the battery module connected serially at discharge. Furthermore, a common contact point of the c contact switch is connected to the minus terminal, a normally open contact point of the c contact switch to be close at electrification from the outside power source is connected to an earth terminal, and a normally close contact point of the c contact switch to be close at power cut from the outside power source is connected to the plus terminal supplied power from the outside power source through a rectifier diode.

### FIELD OF THE INVENTION

The present invention relates to a backup power source for supplying a DC power to an electronic device required for a continuous operation at power cut. In particular, it relates to an art between an electrical charge and discharge circuit equipped with a plurality of battery modules and an embedded controller provided therein.

### BACKGROUND OF THE INVENTION

In an electronic device required for continuous system operation at power cut, there are some systems equipped with a battery backup operation function. Such an electronic device is provided with batteries and electrical charge and discharge circuits to determine a battery voltage/a battery capacity according to a design of system operation guarantee range at power cut. It is an appropriate configuration to scrutinize an input power supply specification and a voltage conversion function in order to realize an electrical charge and discharge circuit suitable for a battery to be connected.

In order to realize a battery backup operation function, an electrical charge and discharge circuit of battery is required and it is necessary to consider a relationship of each voltage between at charge and at discharge. A principal power and voltage of an electronic device having a battery backup operation function is composed of three elements, that is, an input power and voltage to be supplied at electrification, a battery voltage functioned as a power source at power cut, and a system voltage required for realizing an actual function. It is necessary to apply a high voltage rather than a battery voltage to charge to a battery for charging, although a battery is in a charged condition at electrification. It is necessary to supply a system power source only by a battery voltage. In this relationship, the battery voltage must be lower voltage than the input power source and voltage, when the input power source and voltage are applied and charged to a battery. In case where the system voltage guarantees the full functions at a battery, it must be required for having a same operation condition to both input power sources, that is, an input power source voltage and a battery voltage which is lower than the input power source voltage. Then, a voltage conversion function outputting a same voltage to both input voltages must be required. As a result, a power source must be configured to have a relationship of an input power source voltage>a battery voltage>a system voltage (an input power source voltage (larger than) a battery voltage (larger than) a system voltage).

In an electronic device having such a power source configuration, the voltage conversion function generating the system voltage is likely to be realized with use of a semi-conductor IC (Integrated Circuit). In case where a voltage of the system power source is, however, high and electricity consumption is also large, an applicable semi-conductor IC is few, and an applicable device is limited. The higher the voltage of system power source is, the higher the battery voltage must be required. Then, connection stages of battery cells increases in number and the battery module becomes huge. Furthermore, it has a problem in heat generation inside the battery and then it has a bad influence to a reliability and durability of battery.

Accordingly, a relationship among the input power source voltage, the battery voltage, and the system power source voltage, which is not influenced by the system power source voltage and power in use, must be required. It is necessary to lower the battery voltage in order to improve a reliability of the battery module.

As a prior art relating to these problems, it is provided with N pieces of battery modules, (N-1) pieces of switches for serial connection among the battery modules, and N pieces of switches for parallel connection among the battery modules. Then, it discloses an art switching the connection of battery module at charge and discharge between serial and parallel connection in Japanese Patent Unexamined Laid-open Publication No. 53838 of 2007. It is provided with N pieces of battery modules and 2 by (N-1) pieces of c contact switch for respectively switching a plus terminal and a minus terminal to a parallel connection and a serial connection to switch to a parallel connection at charge and a serial connection at discharge in Japanese Patent Unexamined Laid-open Publication No. 340641 of Heisei 8.

### SUMMARY OF THE INVENTION

However, a contact mechanism (switch), which has a double of numbers of battery modules equipped therewith, is required, and is desirable to reduce a number of contact mechanism, which is, in general, high in failure rate compared with semi-conductor in order to improve a reliability of device. Either prior art has the above problems.

In considering the background, an object of the invention is to provide an electrical charge and discharge circuit suitable for supplying power for backup operation to the system power source with use of low-electricity battery module, and the embedded controller.

To achieve the above object, the present invention is characterized in that an electrical charge and discharge circuit for charging and discharging to a plurality of battery modules, connecting in parallel a plurality of battery modules to an outside power source, in case of charging power supplied from an outside power source to the plurality of battery modules, and connecting serially the plurality of battery modules to a load, in case of discharging charged power and supplying power to the load, comprising c contact switch provided between a plus terminal and a minus terminal of the battery module connected serially at discharge. Furthermore, a common contact point of the c contact switch is connected to the minus terminal, a normally open contact point of the c contact switch to be close at electrification from the outside power source is connected to an earth terminal, and a normally close contact point of the c contact switch to be close at power cut from the outside power source is connected to the plus terminal supplied power from the outside power source through a rectifier diode.

Thus, it is designed to generate by serially connecting system power source voltage supplying loads to a plurality of battery modules for low voltage output, and to charge effectively by in parallel connecting a plurality of battery modules at charge. As it can be reduced by about half numbers used in contact mechanism to as about double as numbers of conventional battery module. As a result, it contributes to improve in reliability of the embedded controller having this electrical charge and discharge circuit.

The present invention can provide an electrical charge and discharge circuit suitable for supplying power for backup operation function to a system power source with use of a battery module for low voltage.

### BRIEF DESCRIPTION OF THE DRAWINGS

FIG. 1 is a hardware block diagram showing an example in configuration of electrical charge and discharge circuit in the backup power source having two battery modules.

FIG. 2 is a hardware block diagram showing an example in configuration of electrical charge and discharge circuit in the backup power source having three battery modules.

FIG. 3 is a hardware block diagram showing an example in configuration of power source circuit of embedded controller.

FIG. 4 is a flowchart showing a flow of procedure at the time of charge of embedded controller.

FIG. 5 is a flowchart showing a flow of procedure at the time of discharge of embedded controller.

FIG. 6 is a schematic figuration view of device showing an example of access control system.

### DETAILED DESCRIPTION OF THE PREFERRED EMBODIMENTS

Hereinafter, an embodiment of the present invention will be described with reference to drawings. In each drawing and each embodiment, a duplicate description will be omitted by depicting a same reference numeral in the same or similar element.

### A First Embodiment

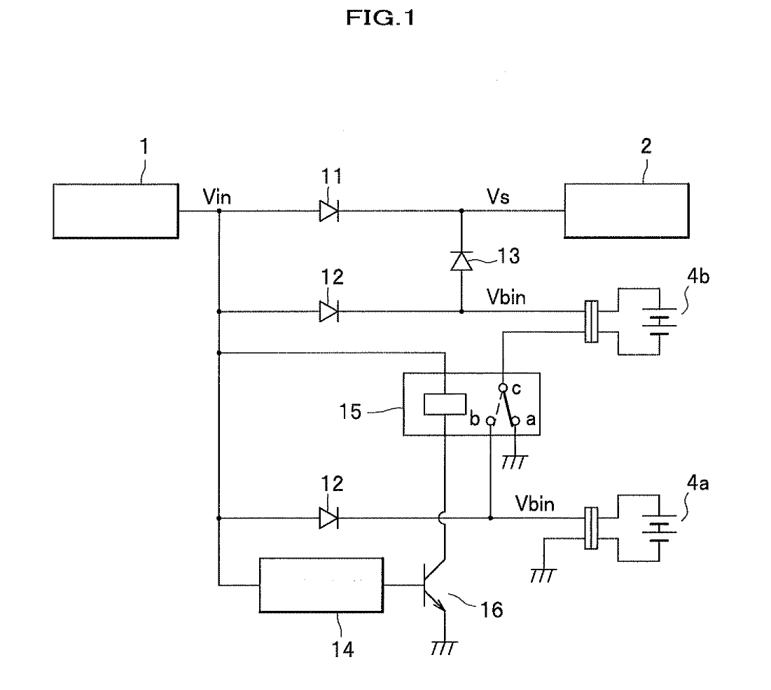

At first, an electrical charge and discharge circuit showing a minimal configuration will be described at the time of configuring a backup power source having two battery modules as a first embodiment of the present invention. FIG. 1 is a hardware block diagram showing in configuration of electrical charge and discharge circuit relating to the first embodiment.

An input source at electrification in this electrical charge and discharge circuit is an AC/DC power source 1 outputting an alternative voltage supplied from the outside to convert and output to a direct voltage. The (direct) output voltage is prescribed as Vin. A (direct) output voltage Vs to a system power source 2 is a value deducting from an output voltage Vin of the AC/DC power source 1 to a voltage drop by a rectifier diode 11. At the time of power cut, the connection of parallel direct relay switch 15 is switched from a contact side to b contact side, and the discharge voltage being direct output voltage at discharge is serially connected between two battery modules 4a, 4b being Vin/2, respectively. The double of the discharge voltage, that is, approximately the same output voltage as Vin is generated, and a value deducting voltage drop by the rectifier diode 13 from it is power supplied to a system power source 2, in order to be about the same as an output voltage Vs at electrification.

Accordingly, as an output voltage to the system power source 2 can be maintained in approximately the same value between at electrification and at power cut, the voltage conversion function in the side of the system power source 2 is not required, and then a semi-conductor IC for voltage conversion is not required. Then, the applicability to large loads in power consumption (voltage, electrical current) improves.

The voltage monitoring IC for power failure detection 14 always monitors an output voltage V in of the AC/DC power source 1. It is judged as electrification when a value Vin goes beyond a first predetermined value for initiating a charge operation. “H” (high level signal) is outputted to a transistor 16 and a transistor 16 is switched to be “ON”. Thus, a coil of parallel direct relay switch 15 with c contact switch is excited to flow the electrical current. The connection of the parallel direct relay switch 15 is switched to a contact side (a connecting condition shown by a thick real line in FIG. 1) being normally open contact point. This results in that two battery modules 4a, 4b make a parallel connection relative to an output of the AC/DC power source 1. As a result, the voltage V bin, which is higher than discharge voltage itself, is applied to each plus terminal of the battery modules 4a, 4b, power to the battery modules 4a, 4b is charged. In addition, the parallel direct relay switch 15 with c contact switch is provided between plus terminal and minus terminal of the battery modules 4a, 4b serially connected at discharge. A common contact point (c) of the c contact switch is connected to the minus terminal. Normally open contact point (a) of the c contact switch, which is closed during electrification from the outside power (AC/DC power source 1), is connected to the earth terminal. Normally close contact point (b) of the c contact switch, in which an outside power is closed during power cut, is connected to the plus terminal supplied power from the outside power through a rectifier diode 12.

On the other hand, in the power cut, the above voltage monitoring IC 14 is judged as power cut when the value Vin goes below a second predetermined value for initiating a discharge operation. “L” (low level signal) is outputted to the transistor 16 and the transistor 16 is switched to be “Off”. Thus, electric current is not flowed through a coil of parallel direct relay switch 15. The connection of the parallel direct relay switch 15 is switched to the b contact side (a connection condition shown by a dotted line in FIG. 1), which is in normally close contact point. This results in that the two battery modules 4a, 4b make a serial connection relative to the system power source 2 as loads. As a result, power discharged from the two battery modules 4a, 4b is supplied to the system power source 2 through the rectifier diode 13.

In this way, a fluctuation of output voltage to the system power source at the time of power cut and power restoration can be reduced without depending on an operation characteristics of the parallel direct relay switch 15 by controlling a switching operation of the parallel direct relay switch 15 with use of the voltage monitoring IC for power failure detection 14. In case where it has no problem in operation characteristics of the parallel direct relay switch 15, the above voltage monitoring IC 14 is not required.

As above described, according to the electrical charge and discharge circuit of the first embodiment, switching a parallel connection and a serial connection in two battery modules during electrification and power cut can be, respectively, realized by the c contact switch.

### A Second Embodiment

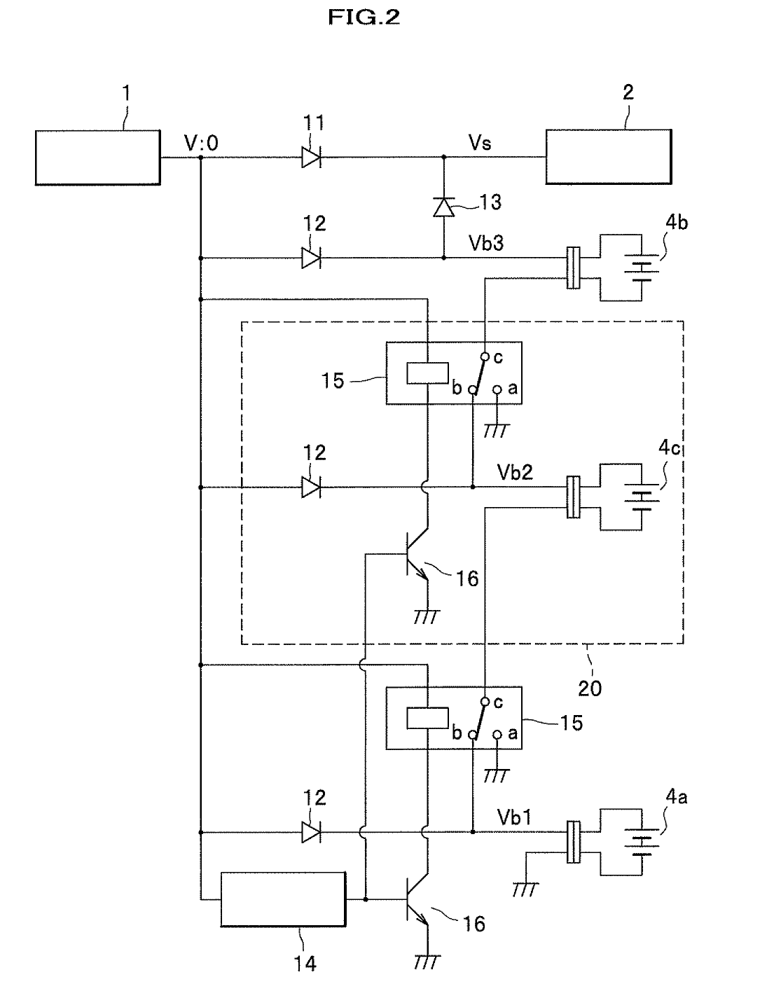

Next, as a second embodiment of the present invention, an electrical charge and discharge circuit in configuration of backup power source providing with at least three battery modules will be described. FIG. 2 is a hardware block diagram showing an example in configuration of the electrical charge and discharge circuit in the backup power source providing with three battery modules relating to a second embodiment.

A principal difference between this electrical charge and discharge circuit and an electrical charge and discharge circuit (FIG. 1) of a backup power source having two battery modules relating to the first embodiment is an additional unit 20 shown by a dotted line frame is added therein. In addition, although a parallel connection and a serial connection are switched between two battery modules 4a, 4b in the electrical charge and discharge circuit in FIG. 1, a parallel connection and a serial connection are switched among three battery modules 4a, 4b, 4c in the electrical charge and discharge circuit of the second embodiment in FIG. 2.

Each discharge voltage of three battery modules 4a, 4b, 4c in this electrical charge and discharge circuit is designated to be approximately a value V in/3 relative to V in, which is an output voltage at electrification of the AC/DC power source 1. Thus, in a condition at the power cut shown in FIG. 2, the connection of two parallel direct relay switch 15 is switched from a contact side to b contact side to serially connect three battery modules 4a, 4c, 4b designed for about Vin/3 of discharge voltage. An output voltage Vb3, which is three times thereof, that is, approximately the same voltage as Vin in the plus terminal of the battery module 4b, is generated, and the voltage deducing voltage drop caused by a rectifier diode 13 becomes approximately the same voltage as the output voltage Vs at electrification. Then, power is supplied to the system power source 2.

The output from the voltage monitoring IC for power failure detection is supplied to both of the parallel direct relay switch 15, and the switching operation of two parallel direct relay switch 15 is synchronized. The other operations will be omitted, as they are the same operation as one of the above first embodiment.

The electrical charge and discharge circuit illustrated in FIG. 2 is configured to add a necessary number of additional units 20 shown by a dotted line frame according to numbers of necessary battery modules. Then, a scale thereof can be easily enlarged. More specifically, in case where N pieces (N is more than or equal to 3) of battery modules are provided, (N-2) pieces of additional unit 20 may be added in the electrical charge and discharge circuit shown in FIG. 1. Then, switching of the parallel connection and the serial connection among N pieces of battery modules at electrification and at power cut according to the electrical charge and discharge circuit relating to the second embodiment can be realized by (N-1) of the c contact switch.

Thus, even in case of high system power source voltage as required, the discharge voltage of each battery module can be maintained to be low by adding a number of battery modules. Accordingly, it can prevent from being huge in battery module and make light of a bad influence on reliability and durability of battery cells caused by internal heat generation.

Even in case where the system power source voltage required by system is different, low-voltage single model of battery modules can be commonly used by adjusting characteristics of rectifier diode and numbers of battery modules.

### A Third Embodiment

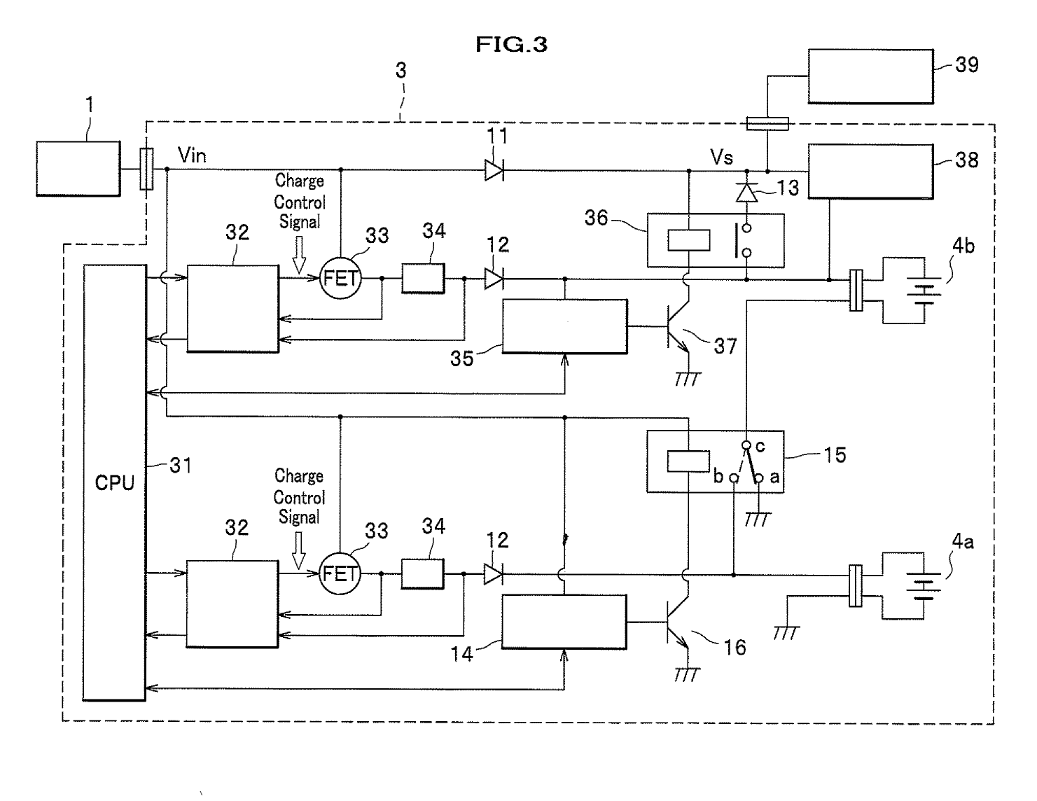

Next, an embedded controller with an electrical charge and discharge circuit relating to the present invention will be described as a third embodiment of the present invention. FIG. 3 is a hardware block diagram showing an example of power source circuit of the embedded controller relating to the third embodiment.

As shown in FIG. 3, the embedded controller 3 is provided with a CPU (Central Processing Unit) 31 realizing various kinds of function as an embedded controller 3 by implementing a control program memorized in a storage device such as a ROM (Read Only Memory) as not shown. In addition, in an internal circuit including CPU 31, as a voltage conversion IC for internal power source supplied power from both of the AC/DC power source 1 and the battery modules 4a, 4b is designed to supply power of reference voltage such as 5V, the CPU 31 operates continuously at power cut.

The CPU 31 is designed to control a controlled device 39 through a communication means as not shown, and control charge and discharge operation by sending and receiving a predetermined signal among a battery charger IC 32 controlling the charge, the voltage monitoring IC for power cut monitor 14, and the voltage monitoring IC for over-discharge monitor 35.

At electrification, the direct power of output voltage Vs is supplied from the AC/DC power source 1 (output voltage V in) through the rectifier diode 11 to the controlled device 39. The charge power to the battery module 4a, 4b is supplied through FET (Field Effect Transistor) 33 controlling ON-OFF by the battery charger IC 32, a resistance for current monitor 34, and a rectifier diode 12.

The electrification is detected in such a way that the CPU 31 compares a value of output voltage V in of the AC/DC power source 1 measured by the voltage monitoring IC for power failure detection 14 with a predetermined value for monitoring electrification. In succession, the CPU 31 outputs a signal respectively indicating an initiation of charge to the voltage monitoring IC for power failure detection 14 and two battery chargers IC 32, and outputs a signal indicating a stop of discharge to the voltage monitoring IC for over-discharging monitor 35.

In this way, when the voltage monitoring IC 14 turns the transistor 16 to be ON, a coil of the parallel direct relay switch 15 is excited to switch to a contact side (a condition shown by a thick real line in FIG. 3), which is normally open contact point. At the same time, the battery charger IC 32 makes the FET 33 to be ON (condition of conduction). As a result, the battery modules 4a, 4b are in parallel connected relative to the AC/DC power source 1 to be charged. When the voltage monitoring IC 35 makes a transistor 37 to be OFF, the coil excitement of the discharge control relay 36 is canceled and a contact of a discharge control relay 36 is switched to be open (condition of non-conduction).

The CPU 31 is designed to get a value of electric current detected based on a voltage difference between both ends of the resistor 34 from the battery charger IC 32, and judge whether the battery modules 4a, 4b are in full charge or not by comparing the value with the predetermined reference electric current. In case where they are in full charge, the power supply to the battery module 4a, 4b is halted to stop charging by instructing the battery charger IC 32 so that the FET 33 maintains a condition of OFF (condition of non-conduction). In this point, as it may be possible that a reduction of charging electric current cannot be detected even in full charge condition of any batteries, the care must be taken at the time of battery selection in case of using this function.

On the other hand, at the time of power cut, direct power having approximately the same voltage as an output voltage Vs at electrification is supplied from the battery modules 4a, 4b serially connected by the parallel direct relay switch 15 through the discharge control relay 36 and the rectifier diode 13.

The power cut is detected in such a way that the CPU 31 compares a value of output voltage V in of the AC/DC power source 1 measured by the voltage monitoring IC for power failure detection 14 with a predetermined value for power failure detection. In succession, the CPU 31 outputs a signal respectively indicating a stop of charge to the voltage monitoring IC for power failure detection 14 and two battery charger IC 32, and outputs a signal indicating a initiation of discharge to the voltage monitoring IC for over-discharging monitor 35.

As a result, when the voltage monitoring IC 14 makes the transistor 16 to be OFF, the coil excitement of the parallel direct relay switch 15 is cancelled, and a contact of the parallel direct relay switch 15 is switched to b contact side (condition shown by a broken line in FIG. 3), which is normally close contact point. At the same time, the battery charger IC 32 makes the FET 33 to be OFF (condition of non-conduction). When the voltage monitoring IC 35 makes a transistor 37 to be ON, a coil of the discharge control relay 36 is excited and a contact point of the discharge control relay 36 is switched to be in close condition (condition of non-conduction). As a result, the battery modules 4a, 4b are serially connected to the controlled device 39 as loads, and the electrical power charged in the battery modules 4a, 4b is supplied to the controlled device 39.

In this way, although electric particles charged in the battery modules 4a, 4b are discharged and the power is supplied to the controlled device 39, the capability and durability of battery can be greatly reduced in case of using a battery in over-discharge condition. In general, when the battery is in over-discharge condition, the discharge voltage of battery greatly reduces. Then, the CPU 31 is designed to monitor voltage at the plus terminal of the battery module 4b measured at voltage monitoring IC for over-discharge monitor 35 at discharge, output a signal indicating a stop of discharge to the voltage monitoring IC 35 at a point going below a reference voltage for judging this voltage to be over-discharge, and switch the transistor 37 to be OFF. In this way, the over-discharge of battery is controlled by cutting a discharge path in order to maintain a contact point of the discharge control relay 36 to be open (condition of non-conduction).

In addition, a circuit for preventing these over discharge may be eliminated, if it is not required for the system. In this case, the voltage monitoring IC 35, the discharge control relay 36, and the transistor 37 are not necessarily required.

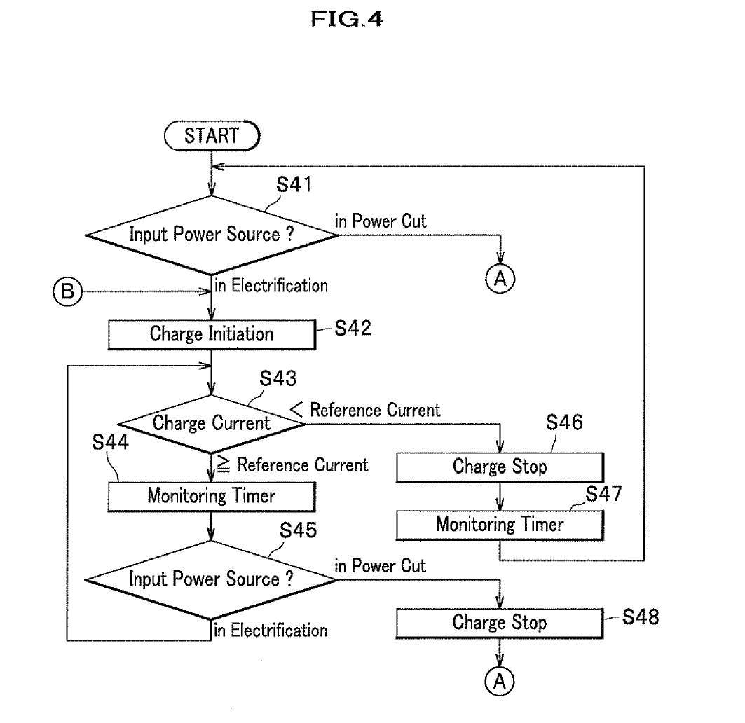

FIG. 4 is a flowchart showing a flow of charge control procedure at electrification of the embedded controller 3. Hereinafter, details of charge control procedure will be described with reference to this flowchart.

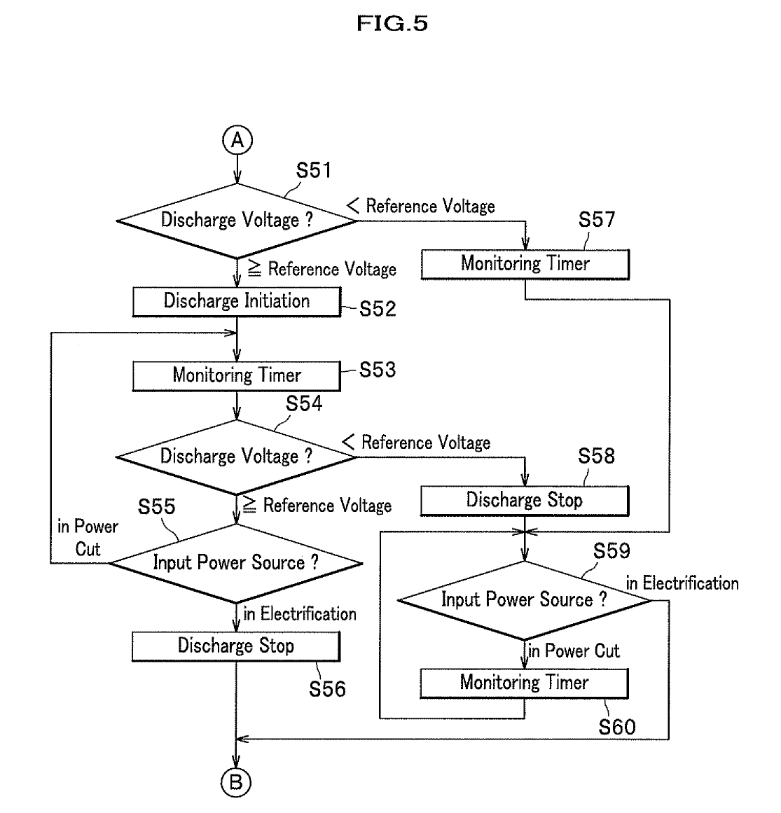

At first, in step S41, CPU 31 is designed to judge whether a condition of input power source is in electrification or in power cut by comparing a value of output voltage V in of the AC/DC power source 1 measured by the voltage monitoring IC for power failure detection 14 with a predetermined value for power failure detection. As a result, when it is judged as in electrification, it proceeds to step S42, and when it is judged as in power cut, it is branched to (A) and proceeds to step S51 in FIG. 5.

In step S42, CPU 31 outputs a signal indicating an initiation of charge to the voltage monitoring IC for power failure detection 14 and two battery charger IC 32, respectively, and outputs a signal indicating a stop of discharge to the voltage monitoring IC for over-discharge monitor 35. Then, the battery modules 4a, 4b initiates charge.

In succession, step S43, CPU 31 judges whether a value of charge current obtained from the battery charger IC 32 is more than or equal to reference current for detecting its full charge or not. As a result, in case where it is judged as being more than or equal to reference current and not reaching to full charge, it proceeds to step S44. On the other hand, in case where it is judged as being less than the reference current and reaching to full charge, it proceeds to step S46.

In step S44, CPU 31 starts a monitoring timer set as a predetermined time (for example, 5 minutes), and in step S45, a condition of input power source is judged again in the predetermined time. As a result, when it is judged as in electrification, it returns to step S43. Then, until charge current goes below the reference current, that is, until it reaches to full charge, the procedure is repeated and it proceeds to step S48, when it is judged as power cut.

In step S48, CPU 31 outputs a signal indicating a stop of charge to the voltage monitoring IC for power failure detection 14 and the two battery charger IC 32, respectively. Then, it stops charging the battery modules 4a, 4b.

In step S46, CPU 31 outputs a signal indicating a stop of charge to the voltage monitoring IC for power failure detection 14 and the two battery charger IC 32, respectively, and stops charge to the battery modules 4a, 4b. In succession, in step S47, it initiates the monitoring timer set in the predetermined time (for example, 5 minutes), and it returns to step S41 in the predetermined time. A condition of input power source is again judged and the above procedures are repeated.

FIG. 5 is a flowchart showing a flow of discharge control procedure at discharge of the embedded controller 3. Hereinafter, details of the discharge control procedure will be described with reference to this flowchart.

In step S51, CPU 31 gets a value of discharge voltage, which is plus terminal voltage of the battery module 4b connected serially to the battery module 4a, from the voltage monitoring IC for over-discharge monitor 35. This value is judged whether it is below a reference voltage for detecting over discharge or not. As a result, in case where it is judged that this value is more than or equal to the reference voltage and it is not in over discharge, it proceeds to step S52. In case where it is judged that this value is less than the reference voltage and it is in over discharge, it proceeds to step S57.

In step S52, CPU 31 switches a contact of the discharge control relay 36 to be in close condition (condition of conduction) by outputting a signal indicating an initiation of discharge to the voltage monitoring IC 35. Then, the controlled device 39 initiates to supply power.

In step S53, CPU 31 initiates a monitoring timer set as predetermined time (for example, 5 minutes), and in step S54, a condition of discharge voltage is judged again in the predetermined time. As a result, when it is judged as that discharge voltage is more than or equal to the reference voltage and is not in over discharge, it proceeds to step S55. When it is judged as that discharge voltage is less than the reference voltage and it is in over discharge, it proceeds to step S58.

In step S55, CPU 31 judges whether a condition of input power source is in electrification or in power cut. As a result, in case where it is judged as in electrification, it proceeds to step S56. In case where it is judged as in power cut, it returns to step S53. Then, until the input power source is recovered and returns in electrification, the above procedures are repeated.

In step S56, CPU 31 switches a contact of the discharge control relay 36 to be in open condition (condition of non-conduction) by outputting a signal indicating a stop of discharge to the controlled device 39. After the power supply is stopped to the controlled device 39, then it branches to (B) and return to step S42. Then, it initiates charge again.

In step S58, CPU 31 switches a contact point of the discharge control relay 36 to be in open condition (condition of non-conduction) by outputting a signal indicating a stop of discharge to the voltage monitoring IC 35 as well as step S56. When it stops supplying power to the controlled device 39, then a condition of input power source is judged again in step S59. As a result, in case where it is judged as in electrification, it branches to (B). Then, it is returned to step S42 in FIG. 4, and initiates charge again. In case where it is judged as in power cut, it proceeds to step S60 and initiates a monitoring timer set in a predetermined time. Then, it is returned to step S59 in the predetermined time, and the above procedures are repeated until the input power source is recovered to be in electrification.

In step S57, CPU 31 starts a monitoring timer set in a predetermined time and proceeds to step S59 in the predetermined time. The above procedures are repeated until the input power source is recovered to be in electrification.

Although charge control procedure and discharge control procedure of the embedded controller 3 has been, hereinafter, described, these procedures may not be executed by CPU, but a part or all of the above procedures may be executed by a hardware circuit having the same function.

It is preferable to provide a means for monitoring a connection of battery module and control ON-OFF of charging power by FET or the like, so that the charge to battery is effective only in a condition of parallel connection.

Furthermore, it is preferable to stop charge in case of detecting over voltage and over current, in order to prevent failure or performance degradation of battery cell caused by over voltage or eddy current.

### A Fourth Embodiment

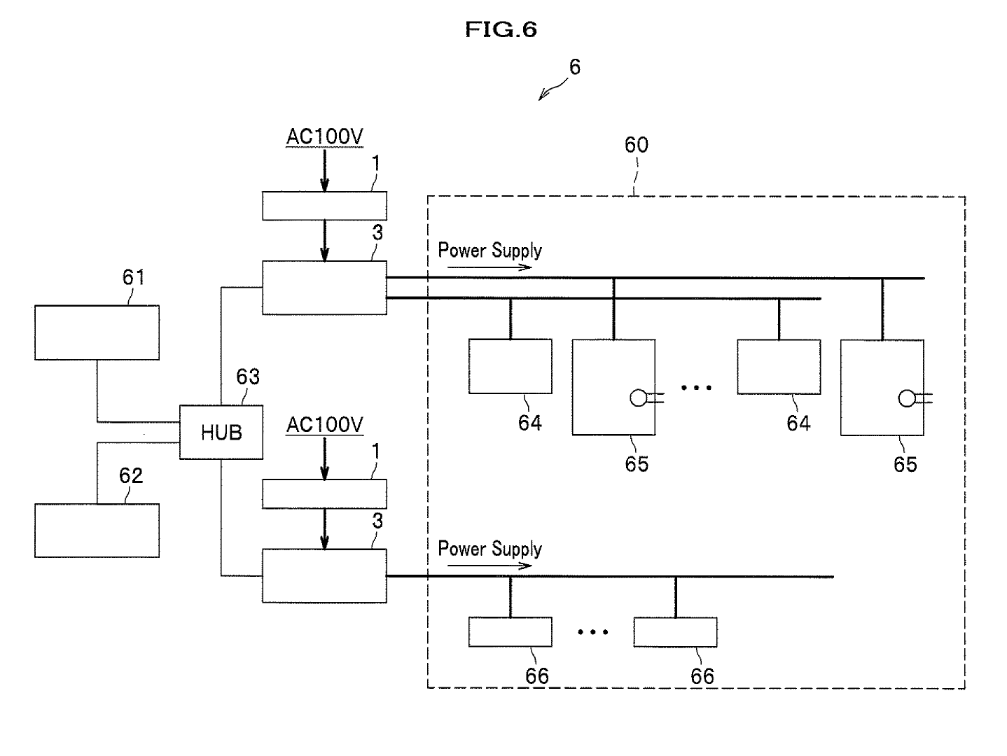

Finally, an example of embedded controller relating to the present invention will be described as a fourth embodiment of the present invention. FIG. 6 is a view showing a schematic device structure of an access control system having an embedded controller relating to the present invention.

As shown in FIG. 6, the access control system 6 is configured to connect to a communication network configured through a HUB 63 or the like among a client PC (Personal Computer) 61, a server 62, and an embedded controller 3 controlling a group of controlled devices 60.

The embedded controller 3 relating to the present invention is provided between the AC/DC power source 1 and devices such as a card reader 64, an electric lock 65, and a sensor 66 constituting a group of controlled devices 60, to send and receive power supply and various kinds of control signal to each device.

As above mentioned, the embedded controller 3 supplies power to the group of controlled devices 60 by receiving power supply from the AC/DC power source 1 at electrification, and charges power to the self-retaining battery. The embedded controller 3 operates continuously each device at power cut by supplying electrical power discharged from the self-retaining battery to the group of controlled devices 60.

In addition, power at power cut to the other device such as the client PC 61, the server 62, and the HUB 63 is supplied from the other backup power source such as UPS (Uninterruptible Power Supply) as not shown.

As above mentioned, although embodiments have been described, embodiments according to the present invention are not limited to these embodiments, but may be changeable within departing from a gist of the present invention. For example, a unit switching between parallel connection and serial connection is not a single battery module, but may be a group of battery modules configured to assemble a plurality of battery modules. A switching means is not limited to an electromagnetic relay, but may be a semi-conductor relay having the same function. An outside power source is not limited to AC power source, but may be DC power source.

1. An electrical charge and discharge circuit for charging and discharging to a plurality of battery modules, connecting in parallel a plurality of battery modules to an outside power source, in case of charging power supplied from an outside power source to the plurality of battery modules, and connecting serially the plurality of battery modules to a load, in case of discharging charged power and supplying power to the load,
comprising c contact switch provided between a plus terminal and a minus terminal of the battery module connected serially at discharge,
wherein
a common contact point of the c contact switch is connected to the minus terminal,
a normally open contact point of the c contact switch to be close at electrification from the outside power source is connected to an earth terminal, and
a normally close contact point of the c contact switch to be close at power cut from the outside power source is connected to the plus terminal supplied power from the outside power source through a rectifier diode.

2. The electrical charge and discharge circuit according to claim 1,
wherein
a value of direct voltage outputted by an AC/DC power source energized from an outside power source is measured,
the common contact point of the c contact switch and the normally open contact point are connected, in case where a measured direct voltage value goes beyond a first predetermined value for initiating a charge operation, and
the common contact point of the c contact switch and the normally close contact point are connected, in case where the measured direct voltage value is less than a second predetermined value for initiating a discharge operation.

3. The electrical charge and discharge circuit according to claim 1,
wherein
an additional circuit with the c contact switch having a same configuration as the above is provided with (N-2) pieces, in case of N of the battery module is at least 3.

4. An embedded controller providing the electrical charge and discharge circuit in claim 1,
wherein
the embedded controller is configured to control continuously by supplying power from a battery self-retained at power cut to a controlled device.

5. The embedded controller according to claim 4,
wherein
the embedded controller further comprises
an electrical current measuring means measuring a value of charge current flowing through the battery module at electrification from the outside power source, and
a charge stop means for stopping charge by interrupting the charge current, in case where a value of the charge current measured by the electrical current measuring means is less than a predetermined value for detecting a full charge.

6. The embedded controller according to claim 4,
wherein
the embedded controller comprises a discharge stop means
measuring a value of direct voltage outputted by the battery module in energizing from the battery module to loads, and
stopping discharge by interrupting power supply from the battery module to the loads, in case where a value of the direct voltage is less than a predetermined value for detecting overdischarge.
